(19) United States
(12) Patent Application Publication
(10) Pub. No.: US 2008/0019625 A1
(43) Pub. Date: Jan. 24, 2008

(54) Spherical plain bearing with contoured lubrication grooves

(75) Inventor: Brian Gaumer, Watertown, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 11/880,138

(22) Filed: Jul. 19, 2007

Related U.S. Application Data
(60) Provisional application No. 60/832,054, filed on Jul. 19, 2006.

(51) Int. Cl. F16C 33/10; B21D 53/10

(52) U.S. Cl. 384/322; 29/898.1

(57) ABSTRACT

A spherical plain bearing has outer and inner rings each having a bearing surface, one bearing surface being in sliding disposition to the other. The inner ring has a third bearing surface for engaging a member to be mounted to the bearing. There is a lubrication groove in one or more of the first, second or third bearing surfaces, the lubrication groove comprising a contoured side. In an alternative a spherical plain bearing, there is a segmented lubrication groove in the third bearing surface that might have a sharp edge or a contoured side. A contoured lubrication groove can be formed by forming a lubrication groove that has a sharp edge; and machining the sharp edge to a contoured side having a reduced tendency to wipe lubricant from a second surface facing the lubrication groove.

This application claims the benefit of U.S. provisional application No. 60/832,054 filed Jul. 19, 2006, which is incorporated herein by reference in its entirety.

### FIELD OF THE INVENTION

The present invention pertains to spherical plain bearings generally and in particular to the protection of the sliding surfaces thereof by providing surface treatments, lubrication grooves and bearing seals.

### BACKGROUND OF THE INVENTION

Spherical plain bearings normally include inner and outer ring members wherein the outer ring member has a spherical concave interior surface that defines a cavity therein, and the inner ring member is disposed in the cavity and has a spherical convex surface that is complementary to, and is dimensioned to match, the interior concave surface of the outer ring member. The concave and convex surfaces are the sliding surfaces or bearing surfaces.

It is known to provide a lubricant between the sliding surfaces of a spherical plain bearing, and to provide a lubrication groove in one of the sliding surfaces. The lubrication groove is a recess from the sliding surface within which a reserve of lubricant can be disposed. The recess is open to the other sliding surface, which can be contacted by the lubricant. As the second surface slides, it carries lubricant between the sliding surfaces to lubricate the bearing. A conventional lubrication groove has sharp edges at the sliding surface of the ring member on which is it formed. The sharp edges tend to wipe lubricant from the surface as one ring moves relative to the other ring, thus inhibiting lubricant from lubricating the bearing.

Based on the foregoing, it is the general object of this invention to provide a spherical plain bearing that improves upon, or overcomes the problems and drawbacks of prior bearings.

### SUMMARY

The present invention resides in one aspect in a spherical plain bearing that comprises an outer ring member having a first bearing surface and an inner ring member having a second bearing surface. The second bearing surface is in sliding disposition to the first bearing surface. The inner ring member has a third bearing surface for engaging a member to be mounted to the bearing. There is a lubrication groove in one or more of the first, second or third bearing surfaces, the lubrication groove comprising a contoured side.

The present invention resides in another aspect in a spherical plain bearing that comprises an outer ring member having a first bearing surface and an inner ring member having a second bearing surface. The second bearing surface is in sliding disposition to the first bearing surface. The inner ring member has a third bearing surface on the interior of the inner ring member, for engaging a member to be mounted in the bearing; and there is a segmented lubrication groove in the third bearing surface.

The present invention also provides, in another aspect, a method of forming a lubrication groove in a spherical plain bearing. The method includes forming a lubrication groove that has a sharp edge; and machining the sharp edge to a contoured side having a reduced tendency to wipe lubricant from a second surface facing the lubrication groove.

### DESCRIPTION OF THE DRAWINGS

FIG. 1A is a schematic partial cross-sectional view of a one embodiment of a spherical plain bearing;

FIG. 1B is a schematic cross-sectional view part of a spherical plain bearing member having a lubrication groove with sharp edges;

FIG. 1C is a schematic cross-sectional view part of a spherical plain bearing member having a lubrication groove with a contoured side;

FIGS. 1D and 1E both are schematic cross-sectional views of part of a spherical plain bearing having a contoured lubrication groove;

FIG. 2A is a partly cross-sectional elevation view of a spherical plain bearing showing a seal between the inner and outer rings;

FIG. 2B is view similar to FIG. 2A with the seal omitted, for clarity;

FIG. 3 is a cross-sectional view of a symmetrically configured seal according to a particular embodiment;

FIG. 4 is partial view of the bearing of FIG. 1A showing the seal between the inner ring and the outer ring; and

FIGS. 5-10 are views similar to FIG. 4 showing alternative embodiments of seal grooves and seals seated therein.

### DETAILED DESCRIPTION OF THE INVENTION

As described herein, a lubrication groove on a first bearing surface may have contoured sides that have a reduced tendency to wipe lubricant from a facing bearing surface, relative to a prior art sharp edge of a lubrication groove. Each side of a contoured groove may be rounded to smoothly blend the interior surface of the groove with the bearing surface, i.e., to meet the first bearing surface in a substantially tangential manner. In this way, he tendency of a sharp edge to wipe lubricant from an opposing second bearing surface that faces the first surface. The side edges may be rounded to conform, in cross-section, to a convex curvature that meets the first bearing surface in a substantially tangential manner, such that the groove surface is substantially blended into the bearing surface.

In an optional embodiment, a spherical plain bearing comprises an outer ring member having a first bearing surface and an inner ring member having a second bearing surface engaging the first bearing surface, i.e., being in sliding disposition to the first bearing surface, and the inner ring member comprises an interior mounting surface that has a segmented lubrication groove therein.

A segmented lubrication groove is one that comprises a first linear portion and a second linear portion that is in fluid communication with, and that extends transversely to, the first linear portion. By being in fluid communication, fluid lubricant that is in the first linear portion of the lubrication groove can easily flow to the second linear portion without having to traverse the bearing surface. Segmented configurations include those that are cruciate, i.e., those in which a second linear portion intersects the first linear portion; those that are T-shaped; and those that merely define angles between two straight portions of the groove. In various embodiments, a cruciate lubrication groove may comprise a plurality of portions that are in fluid communication with, and that extend transversely to, a first linear portion. A segmented lubrication groove allows lubricant to be delivered directly to the mating surfaces of the bearing members over a much greater surface area while the bearing is in use, relative to a conventional, simply linear lubrication groove.

A segmented lubrication groove may be formed on the surface of a bearing that engages a member held by the bearing. For example, a cruciate lubrication groove may be provided in a spherical plain bearing in the interior surface of the inner ring, to face the shaft or other member to be mounted in the bore of the bearing.

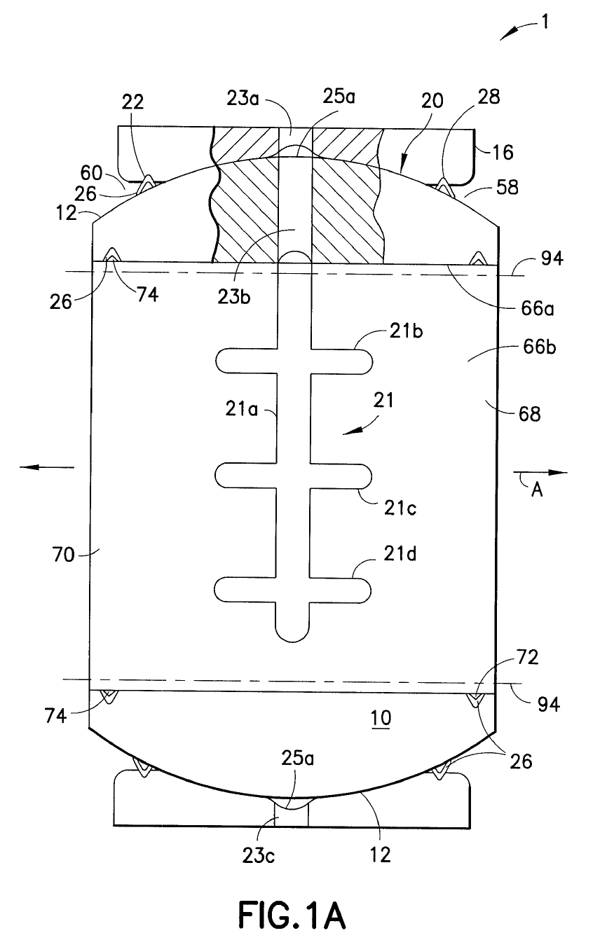

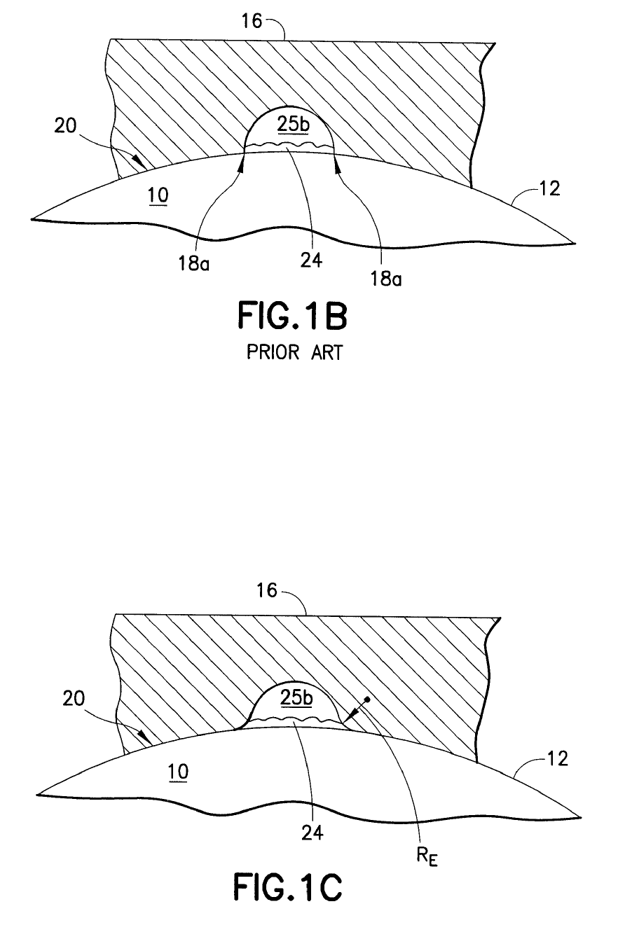

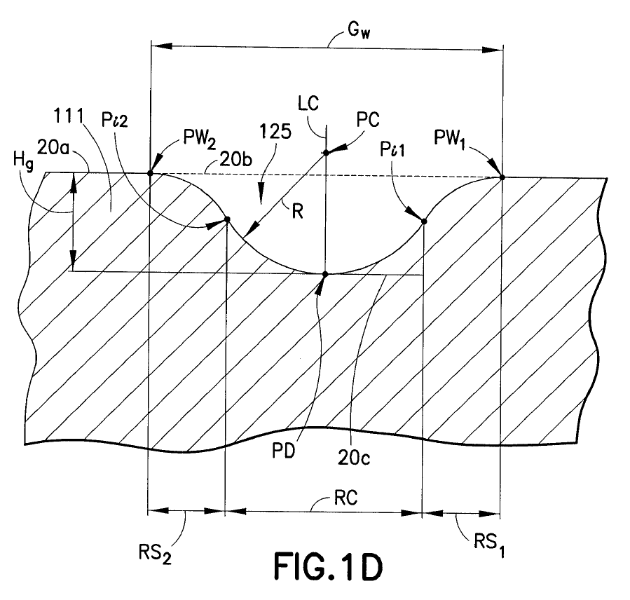

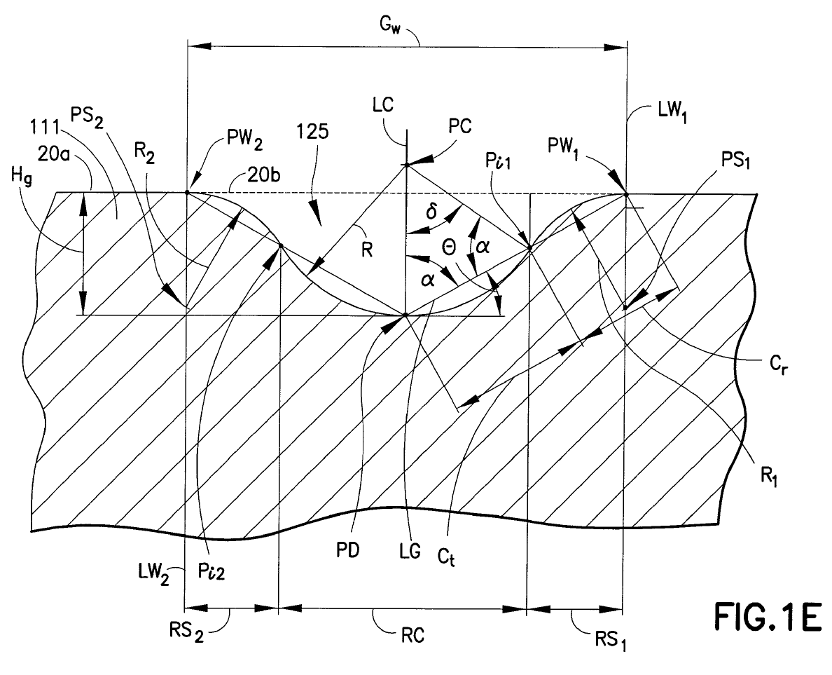

Bearing 1, shown in FIG. 1A, is a spherical plain bearing comprising a first bearing member provided by inner ring 10 and a second bearing member provided by outer ring 16. Inner ring 10 has an annular configuration and has a spherical convex bearing surface 12 dimensioned and configured to engage surface 20. Outer ring 16 has an annular configuration with a central axis A and a spherical concave bearing surface 20 that faces the central axis and is open at axial ends 58, 60. The spherical concave surface 20 has a lubrication groove 25a formed therein as shown in FIG. 1C. There are lubrication supply apertures 23a, 23c in outer ring 16 for providing lubricant to the load zone at the interface of bearing surface 20 and the bearing surface 12 of the inner ring 10. The lubrication supply apertures communicate with lubrication grooves in the bearing surfaces described below.

Inner ring 10 has an interior mounting surface 66a that defines a passage 66b (FIG. 1A) extending therethrough and a central axis therein. Passage 66b defines a first inner ring opening 68 at one end thereof and a second inner ring opening 70 at the opposite end thereof. Ring 10 is disposed in the interior of outer ring 16 with convex surface 12 engaged with concave surface 20.

The interior mounting surface 66a of inner ring 10 has a segmented lubrication groove 21 (seen in FIG. 1A) formed therein that is open to passage 66b. Lubrication groove 21 comprises a generally linear first portion 21a and a generally linear second portion 21b that is in fluid communication with, and disposed in transverse relation to, first portion 21a. In particular, second portion 21b intersects first portion 21a. In addition, lubrication groove 21 comprises optional third portion 21c and forth portion 21d, both of which communicate with and are disposed in transverse relation to first portion 21a.

Lubrication groove 21 communicates with lubricant apertures 23a and 23b in rings 16 and 10, respectively, through which lubricant may be provided. Lubrication groove 21 serves as a reservoir for lubricant thus provided to lubricate interior mounting surface 66a and a mounted member in inner ring 10 to reduce wear, enhance rotational characteristics and decrease rotational friction of the mounted member in the bearing.

As shown in FIG. 1B, a prior art lubrication groove 25b has a conventional configuration, i.e., it is substantially linear and comprises sharp edges 18a at the bearing surface. The lubrication groove serves as a reservoir for lubricant 24 that is drawn into the interface of surfaces 12 and 20 as the bearing functions. However, sharp edges tend to wipe lubricant from surface 12 as ring 10 moves relative to ring 16, thus inhibiting lubricant 24 from lubricating the bearing.

In contrast, bearing 1 has a lubrication groove 25b that has contoured sides, as seen in FIG. 1C. For example, the side may have a rounded cross-sectional profile having an effective radius R_{E} to provide a generally smooth transition between the surface of the lubrication groove 25a and bearing surface 12. As a result, the groove 25a does not have sharp-edged sides that exhibit the wiping tendency of prior art lubrication grooves, and less of lubricant 24 is wiped off of surface 12 than would be if the sides defined sharp edges. Accordingly, more lubricant remains between surfaces 12 and 20 during use of the bearing, thus extending the bearing life. A lubrication groove can be provided with a contoured side in various ways. For example, the bearing can be made with a sharp edge as is known in the art, and the sharp edge can be machined down to the desired profile by means of applying a vibratory finish. Alternatively, the contoured side may be achieved by means of a tool cut.

Details of a specific embodiment of a lubrication groove with contoured sides as described herein are disclosed in relation to the groove 125 shown in FIGS. 1D and 1E. For ease of illustration, bearing surface 20a is show as a flat surface on ring member 111, but it will be understood that groove 125 will be formed in a spherical surface, and that description of the features of groove 125 provided herein will pertain nonetheless to an acceptable approximation. Bearing surface 20a may be either a concave bearing surface (on an outer ring) or a convex bearing surface (on an inner ring).

The groove 125 has a nominal finish depth Hg from the adjacent bearing surface 20a to the deepest point PD in groove 125 measured on a perpendicular from the adjacent bearing surface 20a. Groove 125 also has an overall width Gw, which extends from side point PW1 on the bearing surface to side point PW2, at which points the surface of the groove 125 is machined to tangentially depart towards point PD from the plane 20b of the bearing surface.

The groove 125 has two contoured side regions RS1, RS2 and a central region RC. Central region RC is concave and conforms substantially to a circular arc defined by a central circular radius R. Radius R originates from a point PC that is on a line LC, line LC being perpendicular to the plane of the bearing surface and passing through point PD. In addition, point PC is offset from the plane of the bearing surface so that R is greater than Hg. The surface of the groove in region RC coincides with a circular sector bounded by points Pi1 and Pi2.

The sides of groove 125, which are in side regions RS1 and RS2, are machined to be convex and to conform to substantially circular arcs defined by “blend radii” R1 and R2 (FIG. 1E), respectively. The blend radii R1, R2 originate from points PS1 and PS2 that are on lines LW1 and LW2, lines LW1 and LW2 being perpendicular to the bearing surface at side points PW1 and PW2. The blend radii R1, R2 are smaller in magnitude than Hg. The arcs of side regions RS1 and RS2 are bounded by points Pi1 and PW1 and points Pi2 and PW2, respectively, and merge substantially tangentially with the bearing surface 20a at points PW1 and PW2. The sides of groove 125 merge substantially tangentially with the concave groove surface of region RC at transition points Pi1 and Pi2, where the groove surface changes between being concave and convex.

A line LG drawn from the point PD to a point PW1 passes through the transition point Pi1 and defines angle a relative to Line LC and an angle Θ (=90+−α) relative to a plane 20c parallel to the plane 20b of the bearing surface. The line LG has a first chord Ct that extends between PD and the Pi1 and a second chord Cr that extends from Pi1 to the nearest side point PW1. Preferably, the blend radii R1 and R2 should be at least equal to, or greater than, the chord Cr. The end points of chord Ct define an angle δ having an apex at PC.

In one illustrative embodiment R is equal to about 0.06 inch, angle α is about 60° and radii R1 and R2 are each equal to about 0.04 inch. In addition, groove 125 has a width Gw of about 0.175 inch and a groove depth Hg of 0.05 inch.

In another illustrative embodiment R is equal to about 0.05 inch, angle α is about 54° and radii R1 and R2 are each equal to about 0.009 inch. In addition, groove 125 has a width Gw of about 0.11 inch and a groove depth Hg of 0.04 inch.

In various embodiments, the bearing surfaces of a spherical plain bearing may have or more lubrication grooves that have harp edges or contoured sides, or both.

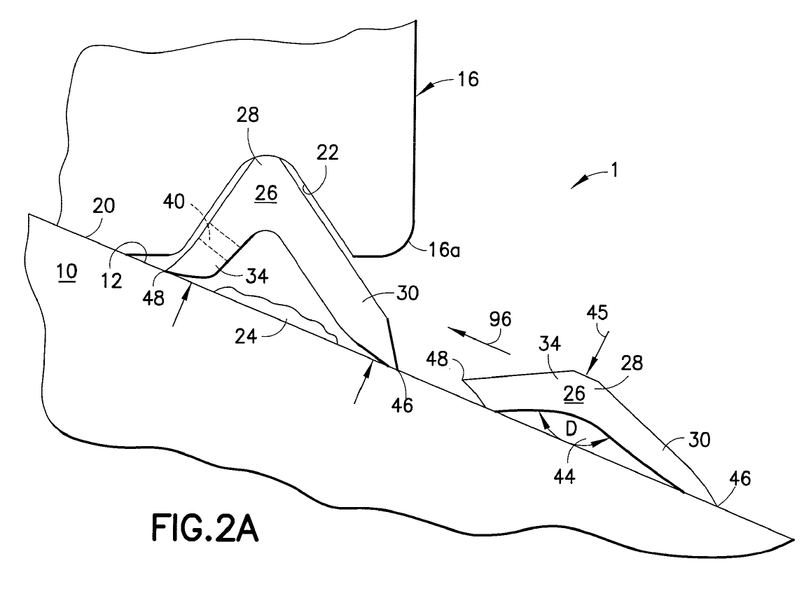

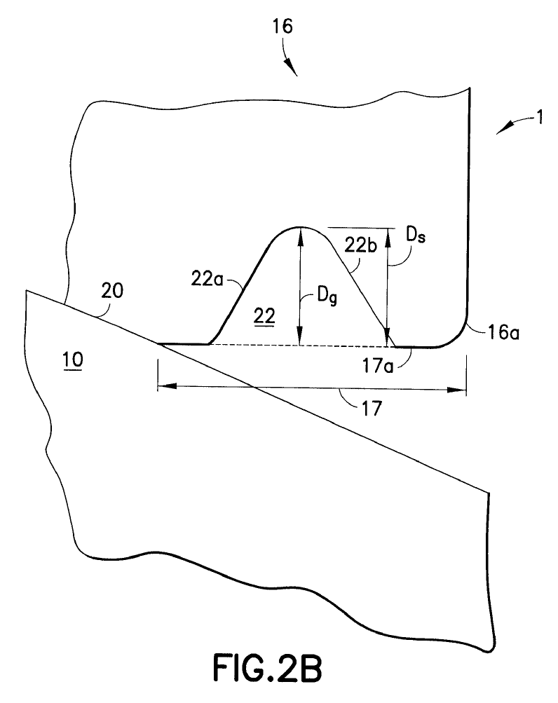

Bearing 1 comprises a seal at each end 58, 60 of the bearing cavity in outer ring 16. To receive the seals, seal mounting grooves 22 (best seen in FIGS. 2A and 2B) extend around the edges of the mated bearing surfaces. Outer ring 16 has end faces 16a and a collect portion 17 (FIG. 2B) between outer ring bearing surface 20 and end face 16a. Seal mounting groove 22 is formed in collet portion 17 of outer ring 16 and has an outward-facing surface 22a (i.e., a surface that faces the nearest end surface of ring 16) and an inward-facing surface 22b (i.e., a surface that faces away from the nearest end surface of ring 16). Groove 22 is symmetric in that outward-facing surface 22a substantially mirrors inward-facing surface 22b. Groove 22 has a groove depth Dg, and inward-facing surface 22b has a surface depth Ds, which is the greatest difference in the diameter of collet portion 17 measured from the deepest point of groove 22 relative to axis A to the most shallow part of collet portion 17 outward from the deepest point of groove 22. In the embodiment of FIGS. 2A and 2B, Ds is substantially the same as Dg because surface 22b is as deep as surface 22a relative to axis A, indicating that groove 22 is entirely between end face 16a and the outermost edge of concave surface 20. In addition, groove 22 is offset from end face 16a, leaving an outward collet surface 17a between inward-facing surface 22b and end face 16a at the axial end of outer ring 16. Collet surface 17a is partially parallel to, and annular about, axis A. The offset is provided so that the ends of ring 16 will have sufficient strength to retain a seal in groove 22 and to resist other stresses of use without damage to ring 16 at end face 16a.

A seal 26 is seated in seal mounting groove 22 and serves to inhibit the loss of lubricant from between inner ring 10 and outer ring 16. Such seals can be of any material such as rubber, but the present invention contemplates the use of plastic. Seal 26 comprises a seal base portion 28 (FIG. 2A) adapted to be conform closely to seal mounting groove 22. Seal 26 includes an outer lip 30 extending downward and laterally outward (i.e., toward axis A and toward the nearest end face 16a) from the seal base portion 28. Preferably outer lip 30 meets surface 12 at an acute angle and extends to contact surface 12 for sealing thereagainst and wiping of that surface.

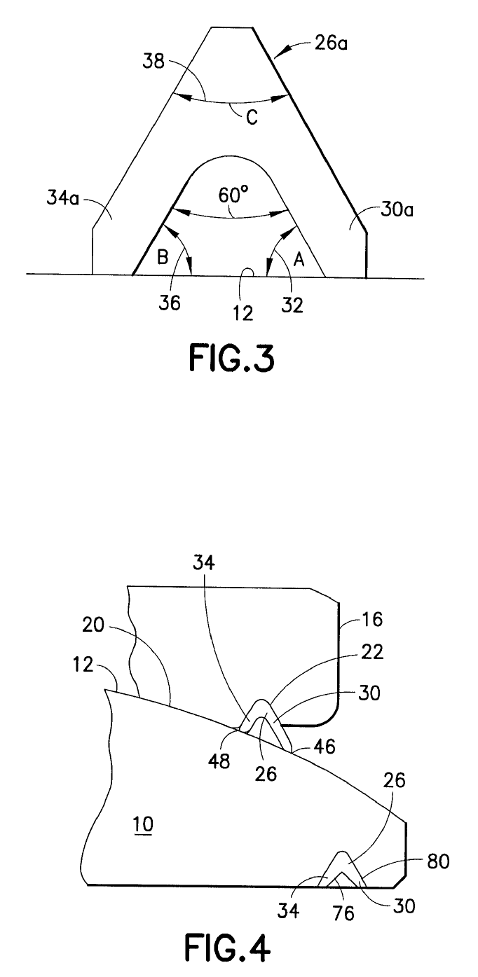

An inner lip 34 extends downward and inward from the seal base portion 28, i.e., toward axis A but away from the nearest end face 16a. Inner lip 34 meets surface 12 at an acute angle (comparable to angle 36 of seal 26a, FIG. 3) and extends inwardly, toward the area of engagement between the inner and outer ring bearing surfaces 12 and 20. In this particular configuration outer lip 30 and inner lip 34 form a downwardly facing V-shape which engages the spherical convex inner ring bearing surface 12 to form a seal against the movement of lubrication passed either of the lips 30 or 34 and also provides double protection against the flow of contaminants inwardly to the lubricating area. The outer surfaces of inner lip 34 and outer lip 30 form an acute angle (comparable to angle 38 of seal 26a, FIG. 3) when seal 26 is in its relaxed state.

To further enhance lubrication, a seal may comprise one or more lubrication holes, such as hole 40 (FIG. 2A) in seal 26, extending through an inner lip 34, optionally at multiple locations about the generally round seal 26. This hole allows lubrication to flow from the area of engagement between the inner ring bearing surface 12 and the outer ring bearing surface 20 to the portion of the outer ring bearing surface 20 located between the inner lip 34 and the outer lip 30 to facilitate lubrication thereof. This hole also allows for overflow lubrication during normal maintenance re-lubrication of the bearing.

Placement of the seal 26 into the seal mounting groove 22 is greatly enhanced by the flexible resilience of seal 26. The positions of seal 26 before and after insertion are shown best in FIG. 2A. In the compressed position, shown in the right of FIG. 2A, the angle 44 between the inner and outer lips 34 and 30, referred to as angle D, will be significantly increased when seal 26 is compressed downwardly by the exertion of force as indicated by the arrow of reference number 45. The exertion of a downwardly directed force manually or by automated installation means will compress the seal 26 to the configuration shown on the right. In this configuration outer lip 30 and inner lip 34 are almost parallel to the inner ring bearing surface 12. This will allow seal 26 to be slided inward until it is in position immediately beneath the seal mounting groove 22, at which point, with the compressive force removed, seal 26 will snap into place as shown in the left portion of FIG. 2A.

Insertion of seal 26 occurs along the inward insertion direction arrow 96. Engagement between the outer lip 30 and the inner lip 34 relative to the generally spherical convex inner ring bearing surface 12 is greatly enhanced by use of pointed ends thereon. In particular the outer lip 30 will preferably define an outer pointed end 46 at the extreme outwardly most portion thereof which greatly facilitates flexible resilience of the lip and wiping of the inner ring bearing surface 12 as desired. In a similar manner the inner lip 34 will preferably include an inner pointed end 48 thereon which facilitates flexible resilience and slight bending or flexing of the inner lip 34 during insertion and after insertion to maintain contact with the bearing surface even after significant wear occurs.

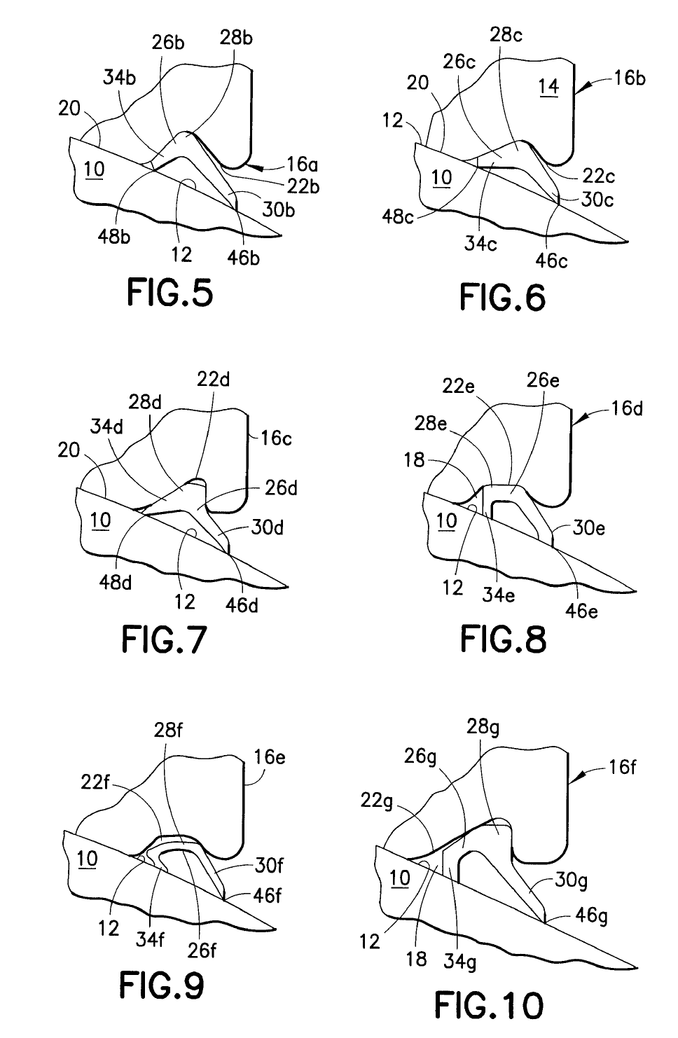

In a particular embodiment, a seal 26a, which may be symmetric in cross-section, as shown in FIG. 3, engages surface 12. In seal 26a, outer lip 30a contacts surface 12 at an acute angle 32 (also indicated as angle A); while inner lip 34a contacts surface 12 at an acute angle 36 (i.e., angle B). When seal 26a is not compressed, the exterior surfaces of lips 30a and 34a define an acute angle 38 indicated as angle C near the seal base, as do the interior surfaces of lips 30a and 34a, which are parallel to the exterior surfaces. In a particular embodiment, angles 32, 36 and 38 may each be approximately sixty degrees. However, in other embodiments, these values can vary as shown in the other drawings for the purposes of providing asymmetrical configurations for seal 26 in FIG. 2A and seals 26b-g, FIGS. 5-10.

The present invention may be embodied with symmetrical or asymmetrical seal mounting grooves and seals, as shown the various Figures (see, e.g., asymmetrical seal mounting grooves 22c, 22d, 22g in FIGS. 6, 7 and 10, and asymmetric seals 26b-26g in FIGS. 5-10) in outer rings 16a-16f. The seals comprise-inner lips 34b-34g, outer lips 30b-30g, seal base portions 28b-28g, and pointed ends 46b-46g and 48b-48d, etc. It should also be appreciated a seal need not have a V-shape cross-section as long as there are still two lips extending outwardly from the seal base portion of the seal. Such configurations are shown best in FIGS. 8, 9 and 10 where there are downwardly directed two sealing lips however the lips are not in the form of a V-shape since they both extend in the same direction, namely, both lips extend outwardly away from the engaging area of the bearing surfaces 12 and 20.

At least a portion of the exterior surface of seal 26 is configured to engage at least a portion of the surface of groove 22 in that the two have complementary mated configurations to provide good contact for holding of the seal base portion 28 firmly within the seal mounting groove 22.

In use, one of the rings of bearing 1 is mounted to a first member, and a second member that is to be movable relative to the first member is mounted to the other ring. For example, outer ring 16 may be mounted to a fixed structure or base, and a member to be movable relative to the base may be mounted to inner ring 10. In such case, the movable member is normally configured to be received in passage 66b of inner ring 10.

Bearing 1 has the advantage of having an effective sealing and wiping of a bearing surface even after an extensive time period of use. This is achievable due to the enhanced wear characteristics of this design. This configuration allows a significant amount of wear to occur on the outer lip 30 and inner lip 34 of the seal 26 of the present invention without seriously effecting sealing and wiping. This is achieved due to the flexible resilience of the material from which the seal member 26 is formed. As shown in FIG. 2 after insertion is made along arrow 96 the inner and outer lips 30 and 34 will still be flexibly compressed to a slight extent. This slight compression will enhance sealing with the bearing surface while at the same time will allow wear to occur while still maintaining this seal. Thus the construction of the inverted V-shaped downwardly facing seal provides a self-adjusting characteristic not present in constructions heretofore.

Most prior art designs include asymmetrical configurations with only a single sealing lip. These configurations have a natural tendency to be easily removed after wear has occurred or to be difficult to position in place initially. The present invention overcomes these difficulties by providing an inner lip 34 as well as an outer lip 30, both of which serve a sealing function. This dual sealing provides enhanced lubrication, further minimizes contamination of the bearing and at the same time provides a self-adjusting characteristic not present in designs at this time. In addition, the seal permits the collection of lubricant therein (in the position of lubricant 24), and the lubricant itself serves as a barrier to the introduction of contaminants (such as environmental dirt or other particulates) into the load zone of the bearing (the region where the spherical surfaces of the inner and outer ring members interface). Moreover, the use of the dual sealing allows for the possibility of flushing degraded or contaminated lubricant out of the load zone by forcing fresh lubricant in via a lubricant aperture. Adequate flushing pressure will allow the fresh lubricant to drive unwanted lubricant past seal 26, and seal 26 will retain the fresh lubricant in the load zone once the flushing pressure is removed.

Optionally, a seal mounting groove and seal as described herein can be used to provide a seal between the interior concave surface of inner ring member 10 and a mounted member 94 (FIG. 1A) which may extend therethrough. As shown in the illustrated embodiment, there is a first groove 72 formed in the convex surface of inner ring 10 adjacent the first inner ring opening 68 to receive an annular seal, the seal being configured to engage a mounted member 94. A similar a second groove 74 will be defined adjacent the second inner ring opening 70 for a seal to be disposed therein to engage the member 94.

The mating surfaces of a spherical plain bearing may be treated to increase the useful life of the bearing in combination with a lubricant, lubrication seal and/or a contoured lubrication groove as described herein. For example, either one or both of the mutually sliding surfaces of a metallic spherical plain bearing may be treated to increase their hardness. Suitable surface treatments include nitriding, carbonitriding and nitrocarburizing. When used in combination with a lubricant and the lubrication seals and/or contoured lubrication grooves as described herein, the hardened surfaces last for a useful lifespan and may be employed in environments in which surface-treated bearings would not otherwise be used.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item. Descriptions of a feature in geometric terms (e.g., rounded, polygonal, circular, etc.) does not require precise adherence to pure geometric forms, but rather allows minor variations to accommodate reasonable manufacturing tolerances. Relative position terms, such as “up” and “upward,” “down” and “downward,” and the like, are meant literally only in relation to the orientation of the Figure with respect to which such terms are used.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

1. A spherical plain bearing comprising:
an outer ring member having a first bearing surface;
an inner ring member having a second bearing surface in sliding disposition to the first bearing surface and a third bearing surface for engaging a member to be mounted to the bearing; and
a lubrication groove in any one or more of the first bearing surface, the second bearing surface or the third bearing surface, the lubrication groove comprising a contoured side.

2. The bearing of claim 1 wherein the lubrication groove has a concave central portion and convex side portions.

3. The bearing of claim 2, wherein the convex side portions blend into the bearing surface in which they are disposed.

4. The bearing of claim 2, wherein the groove is bounded by side points, and wherein the concave portion meets the convex portions at transition points, and wherein each convex side portion has a radius of curvature that is about equal to the distance from an transition point to the nearest side point, and wherein the radius of curvature emanates from a point on a line that is perpendicular to the bearing surface at the side of the groove.

5. The bearing of claim 4, wherein the concave central portion conforms to a second radius of curvature that is greater than the radius of curvature of a side portion, and wherein the second radius of curvature emanates from a point on a line that is perpendicular to the bearing surface at a point at the center of the groove.

6. The bearing of claim 5, wherein the groove has a groove depth and the second radius of curvature is greater than the groove depth.

7. The bearing of claim 1, wherein the inner ring defines a generally spherical convex first bearing surface;
the outer ring having two axial ends and a central axis therethrough, and having an internal surface facing the central axis, the internal surface extending from one axial end to the other, the internal surface comprising a collet portion at each axial end and a generally spherical concave second bearing surface between the collet portions, the second bearing surface engaging said first bearing surface, said outer ring body having a seal mounting groove in each collet portion; and
a seal disposed in each seal mounting groove for contact with the first bearing surface.

8. The bearing of claim 7, wherein each seal mounting groove has a groove depth and comprises an inward-facing groove surface and an outward-facing groove surface, the inward-facing groove surface having a surface depth that substantially coincides with the groove depth.

9. The bearing of claim 8, further comprising an outward collet surface between each inward-facing surface and an axial end of the outer ring.

10. The bearing of claim 7, wherein the inner ring and the outer ring are made of metal and wherein the first bearing surface and the second bearing surface are each treated by a process selected from the group consisting of nitriding, carbonitriding and nitrocarburizing.

11. The bearing of claim 1 wherein the lubrication groove is a segmented lubrication groove.

12. A spherical plain bearing comprising:
an outer ring member having a first bearing surface;
an inner ring member having a second bearing surface in sliding disposition to the first bearing surface,
a third bearing surface on the interior of the inner ring member, for engaging a member to be mounted in the bearing; and
a segmented lubrication groove in the third bearing surface.

13. The bearing of claim 12, wherein the segmented lubrication groove comprises a first generally linear portion and a second generally linear portion that intersects with the first generally linear portion.

14. The bearing of claim 12, wherein the segmented lubrication groove comprises a contoured side.

15. The bearing of claim 12, wherein said inner ring defines a channel extending therethrough and comprising first and second inner ring openings and a seal groove at each end of the channel.

16. A spherical plain bearing as defined in claim 14 wherein said inner ring defines a channel extending therethrough and having first and second inner ring openings and a seal groove at each end of the channel; and further including a supplementary seal mounted in each seal groove for contact with a member mounted therein.

17. The bearing of claim 16, wherein the inner ring is made of metal and has an interior surface that defines the channel, wherein the interior surface is treated by a process selected from the group consisting of nitriding, carbonitriding and nitrocarburizing.

18. The bearing of claim 17, wherein the inner ring and the outer ring are made of metal and wherein the first bearing surface and the second bearing surface are each treated by a process selected from the group consisting of nitriding, carbonitriding and nitrocarburizing.

19. The bearing of claim 12, wherein the inner ring defines a generally spherical convex first bearing surface;
and the outer ring has a central axis therethrough and an internal surface facing the central axis, the outer ring having two axial ends and the internal surface extending from one axial end to the other, the internal surface comprising a collet portion at each axial end and a generally spherical concave second bearing surface between the collet portions, the second bearing surface being in sliding disposition with said first bearing surface, said outer ring body having a seal mounting groove in each collet portion of the internal surface; and
a seal disposed in each seal mounting groove for contact with the first bearing surface;
wherein the first bearing surface and the second bearing surface are each treated by a process selected from the group consisting of nitriding, carbonitriding and nitrocarburizing.

20. A method for forming a lubrication groove in first surface on a spherical plain bearing comprises forming a groove with a sharp edge; and machining the sharp edge to a contoured side having a reduced tendency to wipe lubricant from a second surface facing the lubrication groove.

21. The method of claim 20 comprising forming a groove having a concave central portion and machining the sharp edge to a contoured side having a convex configuration.

22. The method of claim 21 comprising forming a concave central portion having a greater radius of curvature than the radius of curvature of the convex portion of the contoured side.
